(19) United States
(12) Patent Application Publication
(10) Pub. No.: US 2005/0249423 A1
(43) Pub. Date: Nov. 10, 2005

(54) Block decoding method and system capable of decoding and outputting data in a rotated direction

(75) Inventors: Yu-Chu Huang, Taipei City (TW); Yi-Che Chen, Baoshan Township (TW); Chao-Kai Chang, Gaoshu Township (TW)

Correspondence Address: BACON & THOMAS, PLLC, 625 SLATERS LANE, FOURTH FLOOR, ALEXANDRIA, VA, 22314, US

(73) Assignee: Sunplus Technology CO., Ltd., Hsinchu (TW)

(21) Appl. No.: 11/106,442

(22) Filed: Apr. 15, 2005

(30) Foreign Application Priority Data
May 7, 2004 (TW) 093112889

(51) Int. Cl. G06K 9/36

(52) U.S. Cl. 382/233

(57) ABSTRACT

A block decoding method and system capable of decoding and outputting data in a rotated direction, which has a Huffman decoding device, a zigzag device, an inverse quantizer, an inverse discrete cosine device, a data buffer and a controller. In this invention, a dynamically set decoding window is introduced to perform the complete JPEG decoding on blocks in the decoding window and the Huffman decoding on blocks out of the decoding window. When decoding and outputting one or more columns of blocks in the decoding window is complete, the decoding window is dynamically adjusted to a next location for decoding and obtaining a next column of block or a next plurality of columns of blocks.

### BACKGROUND OF THE INVENTION

1. Field of the Invention

The invention relates to a block decoding method and system and, more particularly, to a block decoding method and system capable of decoding and outputting data in a rotated direction.

2. Description of Related Art

Block decoding is a known image compressing/decompressing technique. FIG. 1 is a block diagram of a well-known JPEG decoder 10. As shown in FIG. 1, the JPEG decoder 10 is essentially constructed by a decoding device 110, a zigzag arranging device 120, an inverse quantizer 130, an inverse discrete cosine device 140, a color space converter 150 and a data buffer 160, thereby decoding a compressed datastream 100 in which table data 102 associated with compressed data 101 thereof is provided. The table data 102 includes a coding table 111 and an inverse quantization table 131 such that the decoding device 110 can perform Huffman decoding on the compressed data 101 in accordance with the coding table 111 when the JPEG decoder 10 decodes the compressed datastream 100 to thus obtain a 1-D block consisting of 1-D-arranged pixels. In accordance with the JPEG standard, the zigzag arranging device 120 arranges the 1-D block into a 2-D block consisting of 2-D-arranged pixels, as shown in FIG. 2 in which arrows indicates the sequence of pixel arrangement from the 1-D block to the 2-D block.

The inverse quantizer 130 performs inverse quantization on the 2-D block in accordance with the inverse quantization table 131 to thus obtain a 2-D inverse quantization block. FIG. 3 is an example of a content of the inverse quantization table 131. The inverse discrete cosine device 140 converts the 2-D inverse quantization block from frequency domain to spatial domain. The color space converter 150 performs color conversion on the 2-D spatial block to thus convert its YCbCr format into a RGB format, thereby obtaining a decompressed image block similar to its source image.

The data buffer 160 provides with required memory for temporary data storage when processing of the Huffman decoding, the zigzag arrangement, the inverse quantization and the inverse discrete cosine operation.

As cited, the JPEG decoder 10 requires sequentially decoding the compressed datastream 100 first and then re-combines it into a complete decompressed image 200. For example, as to the decompressed image 200 represented by the smile face shown in FIG. 4, the JPEG decoder 10 sequentially decodes each block 41 in an A direction (in horizontal). However, when printing the decompressed image 200, a typical printer feeds paper in a B direction and fetches each block 41 of the decompressed image 200 in a C direction (in vertical). Accordingly, it is seen that the JPEG decoder 10 decodes the compressed datastream 100 for obtaining every block 41 and storing them to the data buffer 160 first and then fetches the decompressed image 200 in the C direction for printing out. However, the data buffer 160 is increased with higher image resolution for storing more data. For an example of the decompressed image 200 with (M+1)×(N+1) blocks, if every block requires 8×8 byte memory space, the JPEG decoder 10 requires a size of the data buffer 160 up to (M+1)×(N+1)×64 bytes, which needs very high hardware cost.

To overcome the aforementioned problem, the U.S. Pat. No. 5,751,865 granted to Micco, et al. for a “Method and apparatus for image rotation with reduced memory using jpeg compression” discloses that in an encoding and compressing step, the image data is divided into blocks for pre-rotating operation in every block. Also, the location of each block in a JPEG file is record for extracting the data pre-rotated when decoding. However, since such a process needs rotate image in the compressing step, a special compression format is introduced, which cannot support general JPEG processes. In addition, since the JPEG file is rotated, only the vertical decoding can be performed, without a choice of the horizontal or vertical decoding direction.

Further, the U.S. Pat. No. 6,298,166 granted to Ratnakar, et al. for a “Image transformations in the compressed domain” applies the standard JPEG encoding and also records additional information about compressed blocks for every compressed block. The additional information including indexes of the compressed blocks is not included in a source JPEG compressed data but provided for the JPEG decoder. In accordance with the additional information, the JPEG decoder can decode and output data in the vertical direction. However, such a technique requires additional processes in encoding and compressing and stores additional information, which may consume additional compute or hardware or cannot support the standard JPEG decoding easily.

Therefore, it is desirable to provide an improved method to mitigate and/or obviate the aforementioned problems.

### SUMMARY OF THE INVENTION

The object of the invention is to provide a block decoding method and system capable of decoding and outputting data in a rotated direction, which can save the size of data buffer and the required cost without changing a structure of the entire JPEG decoder. In addition, the special compression format can be omitted so that the problem of no support to the general JPEG processes is overcome. The additional information in the prior art is further avoided from the JPEG compression.

In accordance with one aspect of the present invention, there is provided a block decoding method capable of decoding and outputting data in a rotated direction. The decoding method decodes an input compressed datastream to obtain a decompressed data with a plurality of blocks in a 2-D array arrangement, wherein a block (i,j) indicates a block of ith-row and jth-column of the decompressed data, where i, j are integers. The method includes the steps: (A) setting a decoding window having a size of A*B blocks (A, B are integers); (B) performing Huffman decoding to obtain the block (i,j) from the compressed datastream; (C) determining if the block (i,j) locates in the decoding window; (D) performing a complete JPEG decoding on the block (i,j) if it locates in the decoding window and temporarily storing the block (i,j) decoded; (E) determining if all blocks in the decoding window are decoded; and (F) outputting data of the blocks decoded if all blocks in the decoding window are decoded.

In accordance with another aspect of the present invention, there is provided a block decoding system capable of decoding and outputting data in a rotated direction. The decoding system decodes an input compressed datastream to obtain a decompressed data with a plurality of blocks in a 2-D array arrangement, wherein a block (i,j) indicates a block of ith-row and jth-column of the decompressed data, where i, j are integers. The system includes a decoding device, a zigzag device, an inverse quantizer, an inverse discrete cosine device, a data buffer and a controller. The decoding device receives a compressed datastream and perform Huffman decoding on the compressed data, thereby obtaining the block (i, j) consisting of a 1D array of data. The zigzag device is connected to the decoding device for arranging the 1D array of data into a 2-D array of data. The inverse quantizer is connected to the zigzag device for performing an inverse quantization on the 2-D array of data, thereby obtaining a 2-D inverse quantization data. The inverse discrete cosine device is connected to the inverse quantizer for converting the 2-D inverse quantization data from a frequency domain to a spatial domain. The data buffer is connected to the decoding device, the zigzag device, the inverse quantizer and the inverse discrete cosine device for temporarily storing their data generated in decoding. The controller determines if the block (i, j) decoded by the Huffman decoding locates in a decoding window; if yes, a complete JPEG decoding is performed on the block (i, j) and the block (i, j) decoded is temporarily stored in the data buffer; and otherwise, the block (i, j) is discarded.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram of a conventional JPEG decoder;

FIG. 2 is a diagram of a zigzag arrangement in a conventional JPEG decoding;

FIG. 3 is an example of an inverse quantization table for a conventional JPEG decoding;

FIG. 4 is a graph of a conventional decompressed image;

FIG. 5 is a block diagram of a block decoding system capable of decoding and outputting data in a rotated direction in accordance with the invention; and

FIG. 6 is a flowchart of a block decoding method capable of decoding and outputting data in a rotated direction in accordance with the invention;

### DETAILED DESCRIPTION OF THE PREFERRED EMBODIMENT

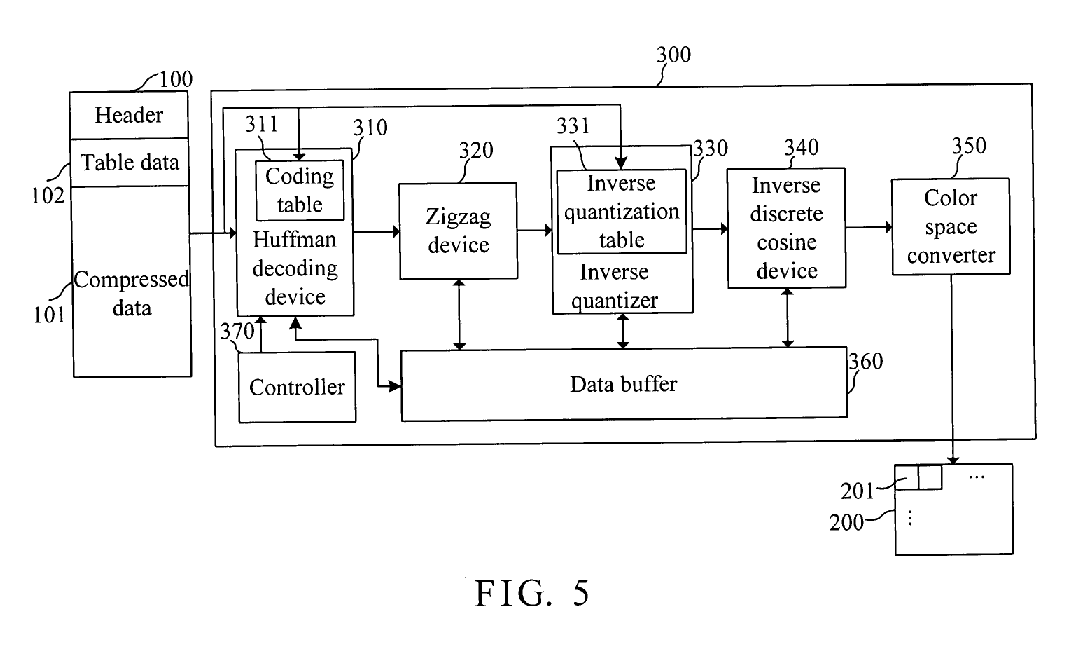

FIG. 5 is a block diagram of a block decoding system capable of decoding and outputting data in a rotated direction in accordance with the invention, which an example of JPEG decoding is given for description. In FIG. 5, the JPEG decoding is applied to decode an input compressed datastream 100 for obtaining a decompressed image 200 having a plurality of blocks 201. The blocks 201 are arranged in a 2-D array, where a block (i, j) indicates a block of i-th row and j-th column of the decompressed image 200, for i=0˜M, j=0˜N, and M, N are integers. The compressed datastream 100 has a table 102 associated with compressed data 101 thereof. The table 102 has a coding table 311 and an inverse quantization table 331. As shown in FIG. 5, the decoding system includes a Huffman decoding device 310, a zigzag device 320, an inverse quantizer 330, an inverse discrete cosine device 340, a data buffer 360, a color space converter 350 and a controller 370.

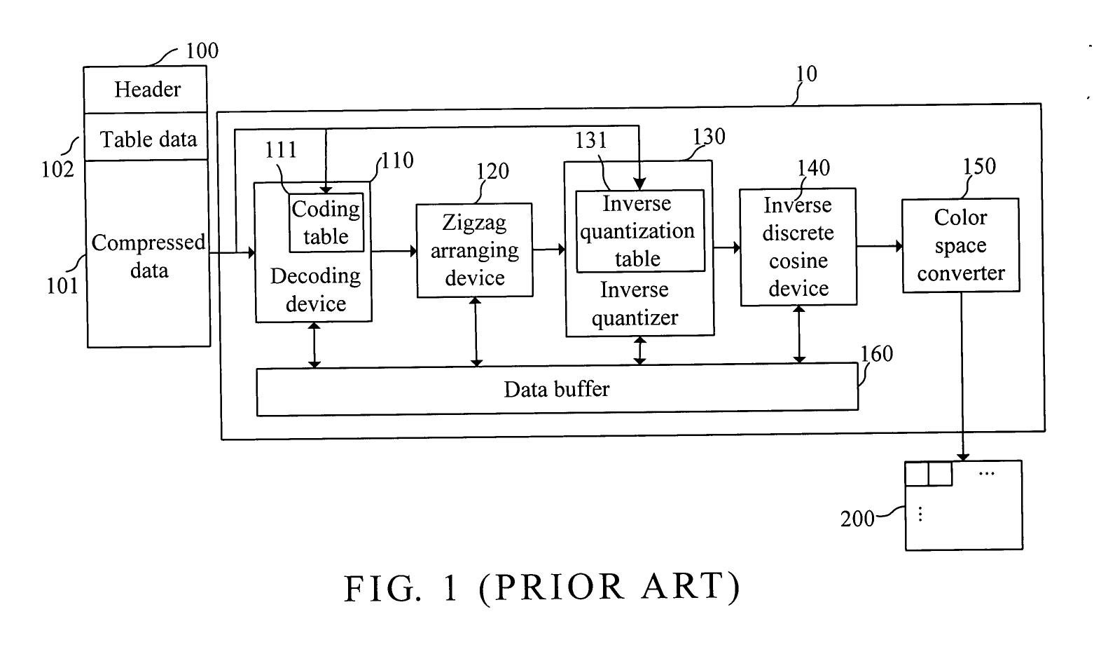

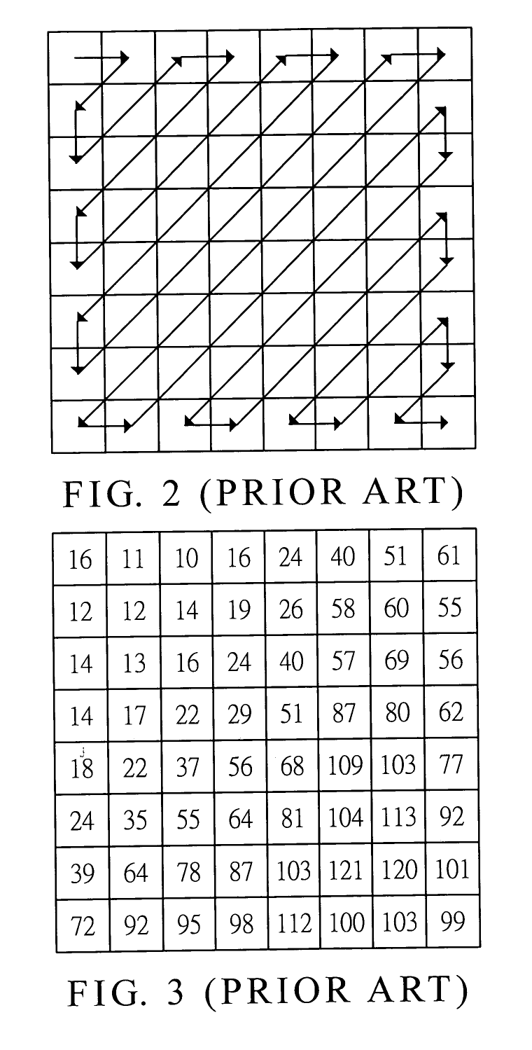

When data in a rotated direction is not selected to decode and output, the devices 310, 320, 330, 340, 350 and 360 can be operated to decode blocks for output, as the typical JPEG decoder shown in FIG. 1. When data in a rotated direction is selected to output, the decoding device 310 receives a JPEG compressed datastream 100 and obtains a Huffman coding table 311 from the JPEG compressed datastream 100. Accordingly, the Huffman decoding is performed on the JPEG compressed datastream for decoding the compressed data to obtain a block (i, j) of data in a 1-D array arrangement. The zigzag device 320 is connected to the decoding device 310 for arranging the 1-D array of data decoded by the decoding device 310 into a 2-D array of data.

The inverse quantizer 330 is connected to the zigzag device 320 for performing inverse quantization on the 2-D array of data in accordance with an inverse quantization table 331 obtained from the JPEG compressed datastream 100, thereby obtaining a 2-D inverse quantization data. The inverse discrete cosine device 340 is connected to the inverse quantizer 330 for converting the 2-D inverse quantization data from frequency domain to spatial domain. The color space converter 350 is connected to the inverse discrete cosine device 340 for performing color conversion on the 2-D spatial data, thereby converting the 2-D spatial data from a YCbCr format into a RGB format. The data buffer 360 is connected to the devices 310, 320, 330 and 340 for providing them with required memory for temporary data generated in decoding.

The controller 370 determines if the block (i, j) decoded by the Huffman decoding device 310 locates in a decoding window; if yes, a complete JPEG decoding is performed on the block (i, j) and the block (i, j) decoded is temporarily stored in the data buffer 360; and otherwise, the block (i, j) is discarded. The decoding window can be a size of A*B (a positive integer each) blocks. To achieve rotation directional decode and output, the decoding window must have a row number equal to that of the decompressed image 200 (A=M). In this embodiment, the decoding window has a column number of 2 (B=2).

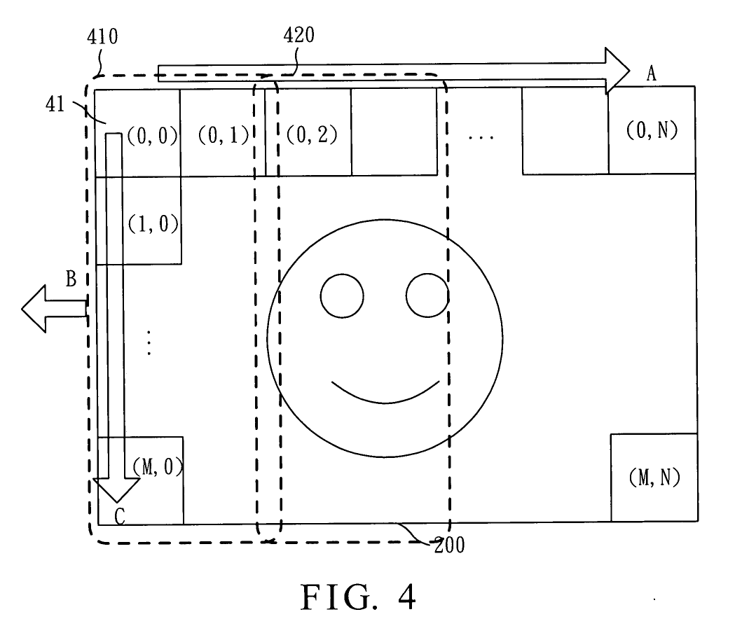

Referring again to FIG. 4 for the decoding window application, the controller 370 dynamically sets a decoding window 410, wherein blocks in the decoding window 410 is performed the complete JPEG decoding while blocks out of the decoding window 410 is performed only the Huffman decoding. In FIG. 4, at the beginning, the decoding window 410 is set to the 0^{th} and first columns. Accordingly, blocks (0, 0) and (0, 1) of the JPEG compressed datastream 100 are performed the complete JPEG decoding and blocks (0, 2) to (0, N) are performed only the Huffman decoding, thereby achieving compressed data of the blocks (1, 0) and (1, 1) in the JPEG compressed datastream 100 by eliminating compressed data of the blocks (0, 2) to (0, N) in the JPEG compressed data 100. Thus, the complete JPEG decoding can be performed on the blocks (1, 0) and (1, 1). As such, the blocks (0, 0), (0, 1), (1, 0), . . . , (M, 1) in the decoding window 410 are performed the complete JPEG decoding and then stored in the data buffer for output. When a block (M, N) is decoded, a decoding window 420 is reset to the second and third columns because the block (M, N) is the last block in the JPEG compressed datastream 100. In this case, blocks (0, 2), (0, 3), (1, 2), . . . , (M, 3) in the decoding window 420 are performed the complete JPEG decoding and then stored in the data buffer for output.

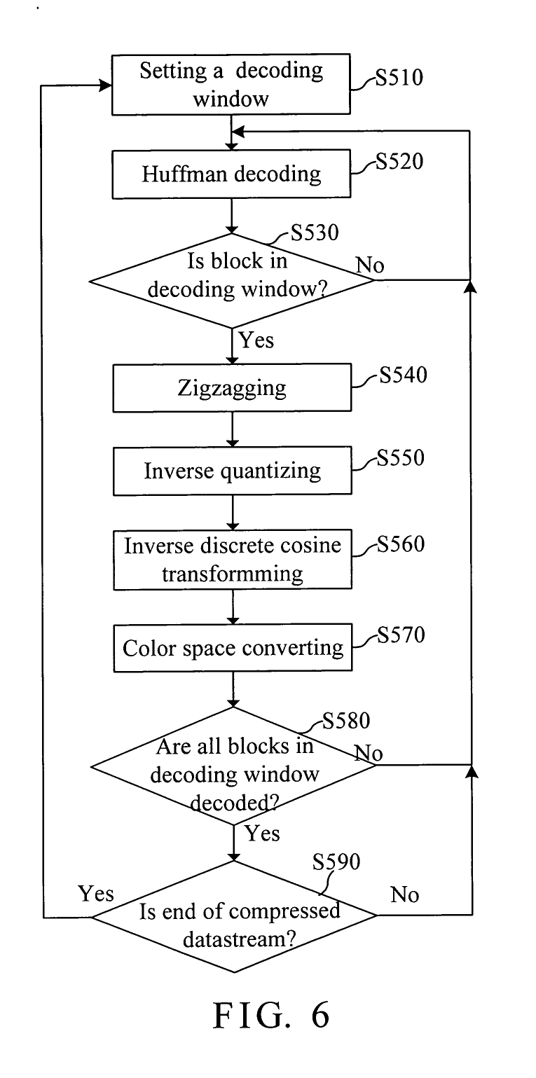

FIG. 6 is a flowchart of a block decoding method capable of decoding and outputting data in a rotated direction in accordance with the invention. As shown in FIG. 6 with also reference to FIG. 4, the method decodes an input JPEG compressed datastream 100 to obtain decompressed data 200 having a plurality of blocks in a 2-D array arrangement, wherein block (i, j) indicates a block of i-th row and j-th column of the decompressed data 200. At start, step S510 sets a decoding window having a size of A*B (a positive integer each) blocks for performing rotation directional decode and output. The decoding window must have a row number equal to that of the decompressed image 200 (A=M). In this embodiment, the decoding window has a column number of 2 (B=2). As cited in the example of FIG. 4, at start, the decoding window 410 is set to the 0^{th} and first columns such that in the JPEG compressed datastream 100, the blocks (0, 0) and (0, 1) are performed the complete JPEG decoding and the blocks (0, 2) to (0, N) are performed only the Huffman decoding.

Step S520 performs the Huffman decoding on the JPEG compressed datastream 100 for obtaining the block (i, j) of data from the JPEG compressed datastream 100, where i and j are integers. Step S530 determines if the block (i, j) locates in the decoding window 410; if yes, the block (i, j) is performed the complete JPEG decoding (S540 to S570) and then temporarily stored in the data buffer.

If the block (i, j) does not locate in the decoding window 410, step S530 discards the block (i, j) and returns to step S520 for performing the Huffman decoding on the JPEG compressed datastream 100, thereby obtaining a next block (i, j+1) of data.

Step 580 determines if all blocks in the decoding window are decoded; if yes, the procedure outputs data of the blocks in the data buffer 360; otherwise, the procedure returns to step S520 for performing the Huffman decoding on the JPEG compressed datastream 100, thereby obtaining a next block (i, j+1) of data.

Step S590 determines if the decoding reaches to the end of the compressed datastream 100, i.e., a block (M, N) is decoded completely; if yes, the procedure returns to step S510 for setting a next decoding window to a next block-decoded location. In this case, as cited in the example of FIG. 4, the next decoding window 420 is set to the second and third columns such that the blocks (0, 2), (0, 3), (1, 2), . . . , (M, 3) in the decoding window 420 are performed the complete JPEG decoding and then stored in the data buffer for output. If the decoding does not reach to the end of the compressed datastream 100, the procedure returns to step S520.

The decoding window is set by four variables: a decoding window starting column (DWSC) and decoding window ending column (DWEC) to accordingly record columns to be decoded; and a decoding window starting row (DWSR) and decoding window ending row (DWER) to accordingly record rows to be decoded. As cited in the example of FIG. 4, at start, the decoding window 410 is set to the 0th and first columns so as to have the DWSC as a value of 0, the DWEC as a value of 1, the DWSR as a value of 0 and the DWER as a value of M. In this case, the blocks (0, 0) and (0, 1) in the JPEG compressed datastream 100 have column indexes of 0 and 1 respectively, which are located from the DWSC to the DWEC such that the complete JPEG decoding is performed. Further, the blocks (0, 2) to (0, N) have column indexes each greater than the DWEC so as to perform only the Huffman decoding.

When a block (M, 0) is decoded, because the row index equals to the value of the DWER and the column index equals to the value of the DWSC, step S580 determines that the blocks in the decoding window are not decoded completely. When a block (M, 1) is decoded, because the row index equals to the value of the DWER and the column index equals to the value of the DWEC, step S580 determines that the blocks in the decoding window are decoded completely.

In view of the foregoing, it is known that the invention has a feature of dynamically setting a decoding window such that the blocks in the decoding window are performed the complete JPEG decoding, and otherwise, only the Huffman decoding is performed. When one or more columns of blocks are obtained by decoding for output, the decoding window is dynamically set to a next location for decoding and thus obtaining a next column of block or next plural columns of blocks. As such, a minimum of the data buffer 360 used by the invention requires only a size of M*1 blocks, much less than a size of M*N blocks in prior art. In addition, changing the structure of the entire JPEG decoder, using the special compression format and generating additional information when performing the JPEG compression are not required. Therefore, the problems in the prior art that the general JPEG processes cannot be supported due to the special compression format and the additional storage and computation or hardware consumption for the additional information are overcome.

Although the present invention has been explained in relation to its preferred embodiment, it is to be understood that many other possible modifications and variations can be made without departing from the spirit and scope of the invention as hereinafter claimed.

1. A block decoding method capable of decoding and outputting data in a rotated direction, which decodes an input compressed datastream to obtain a decompressed data with a plurality of blocks in a 2-D array arrangement, wherein a block (i,j) (i and j are integers) indicates a block of ith-row and jth-column of the decompressed data, the method comprising the steps:
(A) setting a decoding window having a size of A*B (a positive integer each) blocks;
(B) performing Huffman decoding to obtain the block (i,j) from the compressed datastream;
(C) determining if the block (i,j) locates in the decoding window;
(D) performing a complete JPEG decoding on the block (i,j) if it locates in the decoding window and temporarily storing the block (i,j) decoded;
(E) determining if all blocks in the decoding window are decoded; and
(F) outputting data of the blocks decoded if all blocks in the decoding window are decoded.

2. The method as claimed in claim 1, wherein the step (F) further comprises the steps of:
(G) determining if the compressed datastream is decoded completely; and
(H) resetting the decoding window if the compressed datastream is decoded completely, and performing the step (B).

3. The method as claimed in claim 2, wherein the step (G) performs the step (B) if the compressed datastream is not decoded completely.

4. The method as claimed in claim 1, wherein the step (E) performs the step (B) if any block in the decoding window is not decoded.

5. The method as claimed in claim 1, wherein the step (C) discards the block (i, j) of data if the block (i, j) is not in the decoding window and then performs the step (B).

6. A block decoding system capable of decoding and outputting data in a rotated direction, which decodes an input compressed datastream to obtain a decompressed data with a plurality of blocks in a 2-D array arrangement, wherein a block (i,j) (i and j are integers) indicates a block of ith-row and jth-column of the decompressed data, the system comprising:
a Huffman decoding device, which receives the compressed datastream and performs Huffman decoding on the compressed data, thereby obtaining the block (i, j) consisting of a 1-D array of data;
a zigzag device, which is connected to the decoding device for arranging the 1-D array of data into a 2-D array of data;
an inverse quantizer, which is connected to the zigzag device for performing an inverse quantization on the 2-D array of data, thereby obtaining a 2-D inverse quantization data;
an inverse discrete cosine device, which is connected to the inverse quantizer for converting the 2-D inverse quantization data from a frequency domain to a spatial domain, thereby obtaining a 2-D spatial data;
a data buffer, which is connected to the decoding device, the zigzag device, the inverse quantizer and the inverse discrete cosine device for temporarily storing their data generated in decoding; and
a controller, which determines if the block (i, j) decoded by the Huffman decoding locates in a decoding window; if yes, a complete JPEG decoding is performed on the block (i, j) and the block (i, j) decoded is temporarily stored in the data buffer; and otherwise, the block (i, j) is discarded.

7. The system as claimed in claim 6, further comprising:
a color space converter, which is connected to the inverse discrete cosine device for performing color conversion on the 2-D spatial data.

8. The system as claimed in claim 7, wherein the color conversion converts the 2-D spatial data from a YCbCr format to a RGB format.

9. The system as claimed in claim 6, wherein the decoding window has a size of A*B blocks, where A, B are positive integers.

10. The system as claimed in claim 6, wherein the data buffer has a size of A*B blocks, where A, B are positive integers.
